(19) United States
(12) Patent Application Publication
(10) Pub. No.: US 2002/0140853 A1
(43) Pub. Date: Oct. 3, 2002

(54) Sampling rate conversion apparatus and method thereof

(76) Inventors: Seungjoon Yang, Suwon-si (KR); Heon-hee Moon, Seongnam-si (KR); Truong Quang Nguyen, Burlington, MA (US)

Correspondence Address: STAAS & HALSEY LLP, 700 11TH STREET, NW, SUITE 500, WASHINGTON, DC, 20001, US

(21) Appl. No.: 09/916,217

(22) Filed: Jul. 27, 2001

(30) Foreign Application Priority Data
Feb. 20, 2001 (KR) 01-8439

(51) Int. Cl. H04N 7/01; H04N 11/20

(52) U.S. Cl. 348/441

(57) ABSTRACT

A sampling rate conversion apparatus and method of converting the sampling rate of an input signal by supplying an interpolation filter with interpolated data obtained by interpolating data based on a prototype filter according to conversion rate as its coefficients. The sampling rate conversion apparatus includes an interpolator interpolating predetermined data based on a prototype filter according to conversion rate to obtain a desired filter coefficient, and a sampling rate converter performing interpolation filtering on an input signal by the filter coefficient supplied from the interpolator. Therefore, coefficients of an interpolation filter adaptable to various conversion rates can be provided without using a large on-chip memory, thereby attaining a superb interpolated version for the input signal.

### CROSS-REFERENCE TO RELATED APPLICATION

This application claims the benefit of Korean Patent Application No. 2001-8439 filed on Feb. 20, 2001 in the Korean Industrial Property Office, the disclosure of which is incorporated herein by reference.

### BACKGROUND OF THE INVENTION

1. Field of the Invention

The present invention relates to a sampling rate conversion apparatus and a method thereof, and more particularly, to a sampling rate conversion apparatus using an interpolation filter, and a method thereof.

2. Description of the Related Art

A sampling rate conversion apparatus is used to alter an input signal at variable sampling rates. A typical sampling rate conversion apparatus is an image scaler. The sampling rate conversion apparatus generally utilizes an interpolation filter which is a linear phase low-pass filter.

FIG. 1 shows an example of a conventional sampling rate conversion apparatus using an interpolation filter 113, in which a fixed filter coefficient is used. In other words, filter coefficients corresponding to a plurality of conversion (scaling) rates are stored in a filter coefficient storage unit 101. If an arbitrary conversion rate is input, an upsampler 111 of a sampling rate alteration unit 110 determines an upsampling rate Lᵤ and upsamples an input signal x(n) by the upsampling rate Lᵤ to output an upsampled signal u(n) expressed by Equation (1):

$$u ( n ) = ( \begin{matrix}x ( n / {L}_{u} ) , if n / {L}_{u} is an interger . \\ 0 , otherwise\end{matrix} ) \qquad ( 1 )$$

An interpolation filter 113 of the sampling rate alteration unit 110 is a linear phase low-pass filter with a cut-off frequency (Wc) of π/M and uses the Mth band filter. Here, M is the maximum value among upsampling rates Lᵤ and downsampling rates L_{d}. The interpolation filter 113, as the Mth band filter, must satisfy the Equation (2):

$$h ( kM ) = ( \begin{matrix}1 / M for k = 0 \\ 1 for k = \pm 1 , \pm 2 , …\end{matrix} ) \qquad ( 2 )$$

The interpolation filter 113 filters the upsampled signal u(n) using the filter coefficient corresponding to the conversion rate read from the filter coefficient storage unit 101 to output a filtered signal v(n), as represented by:

v(n)=h(n)*u(n) (3)

A downsampler 115 of the sampling rate alteration unit 110 downsamples the signal v(n) filtered by the downsampling rate L_{d} determined by the conversion rate to then output a downsampled signal y(n), as represented by:

$$\begin{matrix}y ( n ) = v ( {L}_{d} n ) \\ = {\sum }_{k ∈ Z} h ( k ) u ( {L}_{d} n - k ) \\ = {\sum }_{m ∈ Z} h ( {L}_{d} n - {L}_{u} m ) x ( m )\end{matrix} \qquad ( 4 )$$

wherein y(n) is an interpolated version of the input signal x(n), whose conversion rate is Lᵤ/L_{d}. The third line of Equation (4) is a polyphase representation and can be employed for a sampling rate alteration unit in FIG. 1, FIG. 2 or FIG. 3.

The sampling rate conversion apparatus, using the Mth band filter as the interpolation filter, is advantageous in that it can be readily extended to two-dimensional conversion.

However, since the Mth band filter coefficients corresponding to various conversion rates are stored in the filter coefficient storage unit 101, a large on-chip memory is necessary. That is to say, K+1 coefficients are necessary for the Mth band filter. Thus, in the case of a sampling rate conversion apparatus capable of accommodating A conversion rates, the filter coefficient storage unit 101 should be able to store A(K+1) coefficients, where K=(N−1)/2 and N=4M−1. Here, N is the length of the Mth band filter. A multiplier “4” coming before the variable M can be set to any other integer, but must be an even number, e.g., 2 or 6, because the length of the Mth band filter has to be an odd number.

To solve the above shortcoming, a sampling rate conversion apparatus has been proposed, as shown in FIG. 2. According to this apparatus, coefficients of a prototype half band filter are cosine-modulated according to the sampling rate to then be supplied to an interpolation filter, that is, the Mth band filter, as its coefficients to be used to alter the sampling rate of the input signal.

In other words, coefficients of a prototype half band filter suitable for an interpolation filter 213 of a sampling rate alteration unit 210 are pre-stored in the filter coefficient storage unit 201. If the conversion rate of an input signal is applied, a filter coefficient modulator 202 reads filter coefficients p(n) stored in the filter coefficient storage unit 201 and performs cosine modulation to obtain an Mth band filter coefficient h_{c}(n) by Equation (5):

$${h}_{c} ( n ) = \begin{matrix}lim p ( n ) \\ x -> n\end{matrix} \frac{sin ( xp / M )}{sin ( xp / 2 )} \qquad ( 5 )$$

However, the Mth band filter coefficient obtained by Equation (5) has poor stopband attenuation, resulting in undesired effects.

Thus, prior to alteration of the conversion rate of the input signal x(n), the input signal x(n) is pre-filtered using a pre-filter 204. The pre-filter 204 pre-filters the input signal x(n) by an M×M size window determined by the conversion rate.

A filter coefficient equalizer 203 equalizes the filter coefficient h_{c}(n) output from the filter coefficient modulator 202 so as to equalize the magnitude distortion generated by pre-filtering, and then supplies the equalized filter coefficient to the interpolation filter 213. The interpolation filter 213 filters an upsampled signal u(n) output from an upsampler 211 by the equalized filter coefficient to then transmit an interpolation-filtered signal v(n) to a downsampler 215. Accordingly, the sampling rate alteration unit 210 outputs an interpolation version y(n) of the input signal x(n).

However, the sampling rate conversion apparatus shown in FIG. 2 has a disadvantage in that computations based on pre-filtering and equalization are complicated, which is especially evident when video sequences are to be processed.

### SUMMARY OF THE INVENTION

Accordingly, it is an object of the present invention to provide a sampling rate conversion apparatus and method converting the sampling rate of an input signal by supplying an interpolation filter with interpolated data obtained by interpolating data based on a prototype filter according to conversion rate as its coefficients.

It is another object of the present invention to provide a sampling rate conversion apparatus and method of converting the sampling rate of an input signal by supplying an interpolation filter with interpolated coefficients obtained by interpolating coefficients of a prototype filter according to conversion rate as its coefficients.

It is yet a further object of the present invention to provide a sampling rate conversion apparatus and method of converting the sampling rate of an input signal by supplying an interpolation filter with an intermediate interpolation result and a final interpolation result in interpolating coefficients of a prototype filter according to conversion rate as its coefficients.

Additional objects and advantages of the invention will be set forth in part in the description which follows and, in part, will be obvious from the description, or may be learned by practice of the invention.

The foregoing objects of the present invention are achieved by providing a sampling rate conversion apparatus including an interpolator interpolating predetermined data based on a prototype filter according to conversion rate to obtain a desired filter coefficient, and a sampling rate converter performing interpolation filtering on an input signal by the filter coefficient supplied from the interpolator.

The predetermined data can be a coefficient of the prototype filter or an intermediate interpolation result obtained in interpolating the coefficient of the prototype filter according to conversion rate.

The above objects of the present invention may also be achieved by providing a sampling rate conversion method including the operations of interpolating predetermined data based on a prototype filter according to conversion rate and obtaining a desired filter coefficient, and performing interpolation filtering on an input signal by the obtained desired filter coefficient to convert the sampling rate of the input signal.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 is a block diagram of a conventional sampling rate conversion apparatus using a fixed filter coefficient;

FIG. 2 is a block diagram of a conventional sampling rate conversion apparatus using cosine modulation;

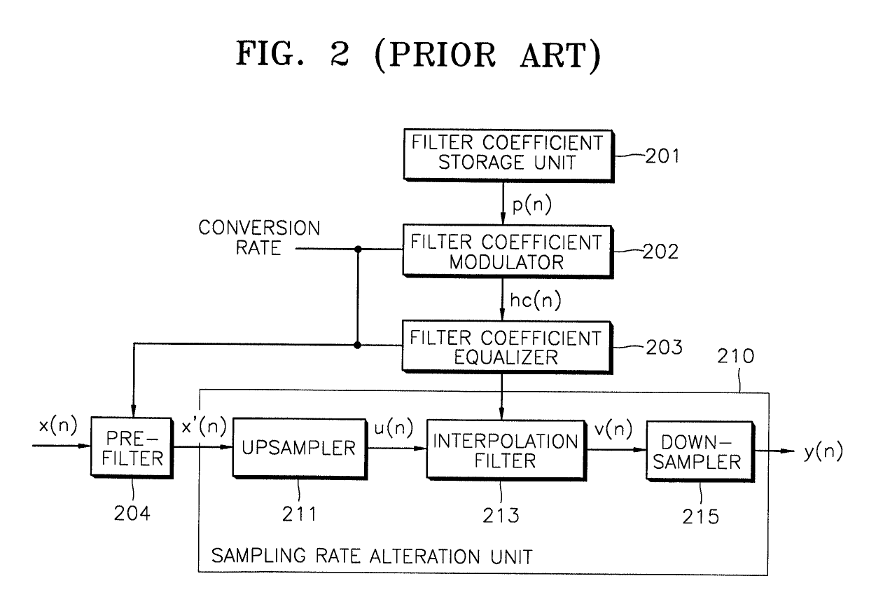

FIG. 3 is a block diagram of a sampling rate conversion apparatus according to the present invention;

FIGS. 4A through 4C illustrate the concept of interpolation by a filter coefficient interpolator shown in FIG. 3; and

FIG. 5 is a flow diagram illustrating the operation of a sampling rate conversion method according to the present invention.

### DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

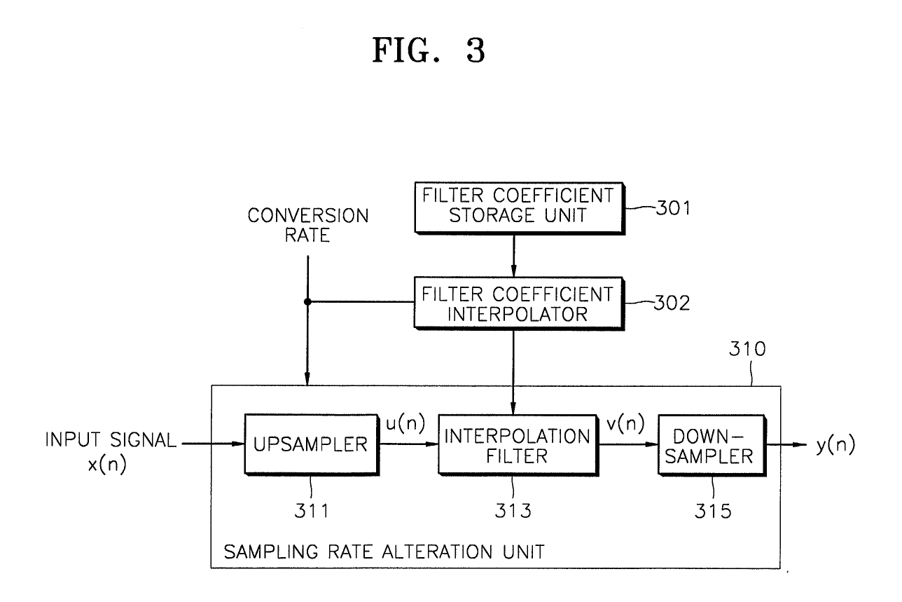

Referring to FIG. 3, a sampling rate conversion apparatus according to the present invention includes a filter coefficient storage unit 301, a filter coefficient interpolator 302 and a sampling rate alteration unit 310. The sampling rate alteration unit 310 includes an upsampler 311, an interpolation filter 313 and a downsampler 315.

The filter coefficient storage unit 301 stores coefficients of a prototype filter, that is, an Mₚth band eigenfilter having a linear phase and a length of 4Mₚ−1, in which p stands for a prototype filter. In order for the prototype filter to be an Mₚth band filter, the prototype filter must satisfy Equation (6):

$${b}_{p} = arg {m}_{b} in {b}^{t} {P}_{p} b \qquad ( 6 )$$

wherein bₚ is a vector defined by {hₚ(0), 2hₚ(1), . . . , 2hₚ(K)}^{t} (K=2Mₚ−1), Pₚ is a matrix of errors occurring at the passband and stopband of the prototype filter. From Equation (6), it can be appreciated that the minimum of b^{t}Pₚb occurs at bₚ. The prototype filter coefficients hₚ satisfying Equation (6), stored in the filter coefficient storage unit 301, are expressed by Equation (7):

hₚ={h(−Kₚ), . . . , h(Kₚ}^{t} (7)

wherein the prototype filter coefficient hₚ is read from the filter coefficient interpolator 302 when an arbitrary conversion rate is applied to the filter coefficient interpolator 302.

The filter coefficient interpolator 302 provides coefficients of the interpolation filter 313 having a linear phase and a length of 4M−1. Here, M is the maximum value among upsampling rates Lᵤ and downsampling rates L_{d}. The interpolation filter coefficients satisfy the Mth band condition given by Equation (8):

$${b}_{d} = arg {m}_{b} in {b}^{t} {P}_{d} b \qquad ( 8 )$$

wherein b_{d} is a vector defined by {h_{d}(0), 2h_{d}(1), . . . , 2h_{d}(K)}^{t}, and h_{d} represents coefficients of the interpolation filter 313, which can be obtained from the prototype filter coefficients by Equation (9):

b_{d}=Tbₚ (9)

In order to obtain coefficients of the Mth band interpolation filter from the prototype filter coefficient using Equation (9), it is necessary to find T. The present invention provides T obtained by regularization.

In obtaining coefficients of the interpolation filter 313, the filter interpolator 302 first interpolates prototype filter coefficients read from the filter coefficient storage unit 301 to produce a continuous function h_{d}(x). Here, in the case of using spline interpolation as the interpolation method, the continuous function h_{d}(x) is given by Equation (10):

$${h}_{d} ( x ) = {\sum }_{k} s ( k ) B ( x - k ) \qquad ( 10 )$$

wherein B(x−k) is spline kernel and s(k) is the solution of Equation (11) or (12).

hₚ=Es (11)

$$( \begin{matrix}h ( - {K}_{p} ) \\ h ( - {K}_{p} + 1 ) \\ ⋮ \\ h ( {K}_{p} - 1 ) \\ h ( {K}_{p} )\end{matrix} ) = \frac{1}{6} ( \begin{matrix}4 & 1 & & & & 0 \\ 1 & 4 & 1 & & & \\ & & & ⋮ & & \\ & & & 1 & 4 & 1 \\ 0 & & & & 1 & 4\end{matrix} ) ( \begin{matrix} s ( - {K}_{p} ) \\ s ( - {K}_{p} + 1 ) \\ ⋮ \\ s ( {K}_{p} - 1 ) \\ s ( {K}_{p} )\end{matrix} ) \qquad ( 12 )$$

As can be understood from Equations (11) and (12), s is easily obtained from the matrix E consisting of constants available from the spline kernel and the prototype filter coefficients hₚ supplied from the filter coefficient storage unit 301. If the continuous function h_{d}(x) is obtained by s and Equation (10), the desired Mth interpolation filter coefficients h_{d} are obtained by sampling the continuous function h_{d}(x) at equally spaced (4M−1) points. The conditions of the sampling points are variable according to conversion rate, because M is determined by the conversion rate. This procedure can be written as:

h_{d} BE⁻¹hₚ (13)

wherein B is a matrix consisting of values of the spline kernel at (4M−1)×(4Mₚ−1) points.

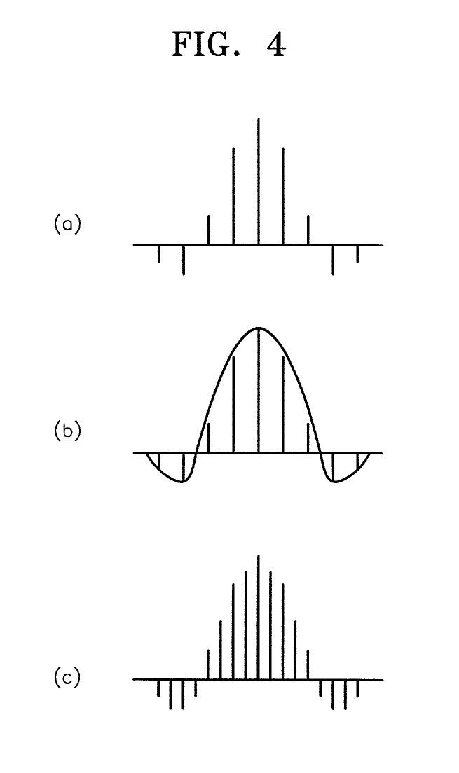

FIG. 4A shows prototype filter coefficients read from the filter coefficient storage unit 301, FIG. 4B is a characteristic diagram of the continuous function obtained by the read filter coefficients, and FIG. 4C shows interpolated prototype filter coefficients according to the applied conversion rate.

Although it has been described in the above embodiment that interpolation is performed by the filter coefficient interpolator 302 using spline interpolation, the invention can be implemented by interpolating filter coefficients read from the filter coefficient storage unit 301 according to conversion rate by way of known linear interpolation, quadratic interpolation or cubic interpolation, thereby obtaining the desired coefficients of the interpolation filter 313.

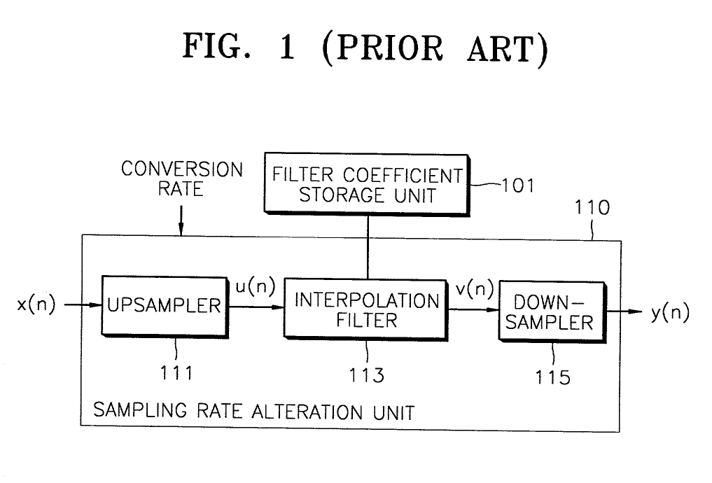

The structure and operation of the sampling rate alteration unit 310, including the upsampler 311, the interpolation filter 313 and the downsampler 315, are the same as those shown in FIG. 1. In particular, since the length of the prototype filter is 4Mₚ−1, which is stored in the filter coefficient storage unit 301, the interpolation filter 313 has to be the Mth band filter having a length of 4M−1. Also, as described above in FIG. 1, if an interpolated filter coefficient is supplied to the interpolation filter 313, the interpolation filter 313 interpolation-filters an upsampled signal u(n) and transfers the interpolation-filtered signal v(n) to the downsampler 315. The downsampler 315 downsamples the interpolation-filtered signal v(n) to output an interpolation version y(n) of the input signal x(n).

The above-described sampling rate conversion apparatus can also be used when image or video size conversion is intended. In order to implement sampling rate conversion, it has been described in the above-described embodiment that prototype filter coefficients are stored in the filter coefficient storage unit 301. However, the value of s, which is an intermediate interpolation result obtained for interpolation in Equations 11 and 12, can also be stored in the filter coefficient storage unit 301. In other words, the value of s is stored in the filter coefficient storage unit 301, instead of prototype filter coefficients, and then the stored value of s is read in response to the application of conversion rate, to obtain a continuous function h_{d}(x). Then, h_{d} sampled at a sampling point, which is determined according to the applied conversion rate, may be provided as an interpolation filter coefficient. Accordingly, desired interpolation filter coefficients can be obtained more simply than the method proposed with reference to FIG. 3, by implementing sampling rate conversion using the value of s.

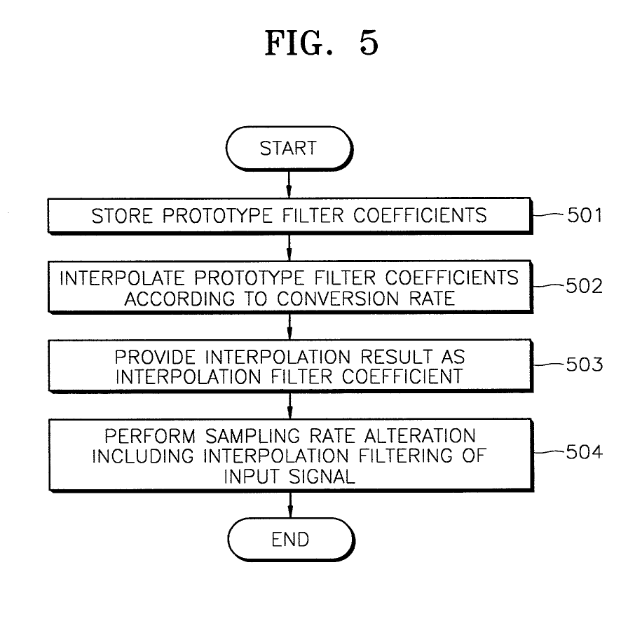

FIG. 5 shows the implementation of a sampling rate conversion method according to the present invention. In operation 501, prototype filter coefficients satisfying corresponding requirements of the interpolation filter 313 are stored. In operation 502, when an arbitrary conversion rate is applied, the stored prototype filter coefficients are read and then interpolated according to a preset interpolation method and the applied conversion rate. The preset interpolation method includes known interpolation methods such as spline interpolation, linear interpolation, quadratic interpolation, cubic interpolation and the like, as implemented in FIG. 3. In operation 503, the interpolation result is provided as a coefficient of the interpolation filter 313. Accordingly, in operation 504, the interpolation filter 313 performs interpolation filtering on an upsampled signal transmitted from the upsampler 311 by the provided coefficient to then be output. The output signal is downsampled by the downsampler 315 to output an interpolated signal y(n) of the input signal x(n).

According to the present invention, the sampling rate of an input signal is converted such that a prototype filter coefficient is interpolated in real-time according to conversion rate and then the interpolation result is provided as an interpolation filter coefficient, that is, an Mth band filter. Therefore, coefficients of an interpolation filter adaptable to various conversion rates can be provided without using a large on-chip memory, thereby attaining a superb interpolated version for the input signal.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A sampling rate conversion apparatus comprising:
an interpolator interpolating predetermined data based on a prototype filter according to conversion rate to obtain a desired filter coefficient; and
a sampling rate converter performing interpolation filtering on an input signal by the filter coefficient supplied from the interpolator.

2. The sampling rate conversion apparatus according to claim 1, wherein the interpolator obtains the filter coefficient by selecting from one of spline interpolation, linear interpolation, quadratic interpolation and cubic interpolation.

3. The sampling rate conversion apparatus according to claim 1, wherein the predetermined data is a coefficient of the prototype filter.

4. The sampling rate conversion apparatus according to claim 1, wherein the predetermined data is an intermediate interpolation result obtained in interpolating the coefficient of the prototype filter according to conversion rate.

5. The sampling rate conversion apparatus according to claim 1, further comprising a storage unit storing the predetermined data.

6. The sampling rate conversion apparatus according to claim 1, wherein the interpolator obtains a continuous function based on the predetermined data, samples the continuous function at points determined by conversion rate to obtain the desired filter coefficient.

7. The sampling rate conversion apparatus according to claim 1, wherein the sampling rate converter converts the size of an image or video.

8. A sampling rate conversion method comprising:
interpolating predetermined data based on a prototype filter according to conversion rate and obtaining a desired filter coefficient; and
performing interpolation filtering on an input signal by the obtained desired filter coefficient to convert the sampling rate of the input signal.

9. The sampling rate conversion method according to claim 8, wherein the obtaining of the desired filter coefficient comprises:
obtaining a continuous function based on the predetermined data; and
obtaining a sampling result on the continuous function, which is the desired filter coefficient, at points determined by conversion rate.

10. The sampling rate conversion method according to claim 8, wherein the predetermined data is a coefficient of the prototype filter.

11. The sampling rate conversion method according to claim 8, wherein the predetermined data is an intermediate interpolation result obtained in interpolating the coefficient of the prototype filter according to conversion rate.

12. The sampling rate conversion apparatus according to claim 1, wherein the prototype filter is an Mₚth band eigenfilter having a linear phase and a length of 4Mₚ−1, in which p stands for a prototype filter.

13. The sampling rate conversion apparatus according to claim 12, wherein the protototype filter satisfies the equation:
$${b}_{p} = arg {m}_{b} in {b}^{t} {P}_{d} b$$
wherein bₚ is a vector defined by {hₚ(0), 2hₚ(1), . . . , 2hₚ(K)}^{t} (K=2Mₚ−1), Pₚ is a matrix of errors occurring at the passband and stopband of the prototype filter, and hₚ are the prototype filter coefficients.

14. The sampling rate conversion apparatus according to claim 13, wherein the prototype filter coefficients hₚ are expressed by the equation:
hₚ={h(−Kₚ), . . . , h(Kₚ}^{t}

15. The sampling rate conversion apparatus according to claim 3, wherein the interpolator interpolates prototype filter coefficients to produce a continuous function h_{d}(x).

16. The sampling rate conversion apparatus according to claim 3, wherein spline interpolation is used to produce the continuous function h_{d}(x) expressed by:
$${h}_{d} ( x ) = {\sum }_{k} s ( k ) B ( x - k )$$
wherein B(x−k) is spline kernel and s(k) is the solution of Equation (11) or (12).

17. The sampling rate conversion apparatus according to claim 1, wherein the sampling rate converter comprises an upsampler, an interpolation filter and a down sampler.

18. A sampling rate conversion apparatus comprising:
an interpolator interpolating a filter coefficient in real time based on a prototype filter according to conversion rate to obtain a desired filter coefficient; and
a sampling rate converter performing interpolation filtering on an input signal by the filter by the filter coefficient supplied from the interpolator.
